(19) United States
(12) Patent Application Publication
(10) Pub. No.: US 2026/0278125 A1
(43) Pub. Date: Sep. 17, 2026

(54) SEARCH RUNTIME ACCESS CONTROL MASKING

(71) Applicant: NVIDIA Corporation, Santa Clara, CA (US)

(72) Inventors: Vikram Sharma Mailthody, Urbana, IL (US); Jean-Luc Watson, Palo Alto, CA (US); Corey Nolet, Crofton, MD (US)

(21) Appl. No.: 19/080,269

(22) Filed: Mar. 14, 2025

(51) Int. Cl. G06F 21/60; G06F 21/62

(52) U.S. Cl. CPC G06F 21/604; G06F 21/6218

(57) ABSTRACT

Systems and methods are provided for controlling access to records in a database, such as a vector database, during search operations such as vector search operations. At least one embodiment relates to accessing a permission vector indicating access rights for a user to a plurality of records stored in a database, and searching the database using the permission vector to mask access to prohibited records during search traversal.

### TECHNICAL FIELD

The present disclosures relate to database search systems and, in at least one embodiment, to fast retrieval with access control for permission management applied at vector search runtime.

### BACKGROUND

Database systems store and manage large collections of data. As databases grow in size and complexity, efficient methods for retrieving relevant information become increasingly challenging. Various approaches exist for organizing and accessing data within database systems.

Database systems commonly implement access control mechanisms to regulate which users can access different portions of stored data. These access control systems help organizations maintain data security and privacy requirements.

### BRIEF DESCRIPTION OF THE SEVERAL VIEWS OF THE DRAWINGS

Example embodiments are described in detail below with reference to the attached drawing figures.

FIG. 1 is a block diagram illustrating a system for controlling access to records during database search operations, according to at least one embodiment.

FIG. 2 is a flowchart illustrating a method for masking access to prohibited records during search traversal using a permission vector, according to at least one embodiment.

FIG. 3 is a diagram illustrating generation of a permission vector from access control data and user group membership data, according to at least one embodiment.

FIG. 4 is a diagram illustrating application of a permission vector to an adjacency matrix to generate a masked adjacency matrix, according to at least one embodiment.

FIG. 5 is a flowchart illustrating a method for search traversal to identify candidate records using a masked adjacency matrix and multi-hop traversal, according to at least one embodiment.

FIG. 6 is a diagram illustrating identification of additional candidate records through the prohibited record traversal operation of FIG. 5, according to at least one embodiment.

FIG. 7 is a block diagram of an example computing device suitable for use in implementing at least some embodiments of the present disclosure.

FIG. 8 is a block diagram of an example data center suitable for use in implementing at least some embodiments of the present disclosure.

### DETAILED DESCRIPTION

Systems and methods are disclosed related to search runtime access control masking.

At least one embodiment relates to systems and methods for controlling access to records during database search operations, particularly in vector databases and vector search systems.

A database search system includes components for managing permissions and controlling access during database search operations. A permission management subsystem processes access control data and user group membership data to generate permission vectors indicating which records a user can access. These permission vectors can be cached to improve efficiency when permissions remain unchanged.

Vector search systems enable efficient retrieval of information from large databases by representing data as high-dimensional vectors and using similarity-based indexing approaches. These systems organize vector data using graph structures and matrix representations to facilitate fast nearest-neighbor search operations. Vector databases store and index vector embeddings derived from various data types including text, images, and other unstructured content, allowing for semantic similarity comparisons during search operations.

Records of a vector database can be organized using graph-based indexes in which relationships between records are represented as connections between nodes. An indexing subsystem maintains these graph indexes and associated adjacency data that describes how records are connected to each other. As used herein, the terms “node” and “record” may sometimes be used interchangeably to refer to nodes of a graph index corresponding to records in a database indexed by the graph index.

At least one embodiment addresses challenges in efficiently enforcing access control in vector search systems. Prior approaches include segmenting records into separate collections based on permissions, pre-filtering before search, post-filtering after search, or modifying indexes to incorporate permissions; each of these existing approaches exhibits limitations in terms of efficiency, maintenance overhead, and/or comprehensiveness of results.

In at least one embodiment, a search traversal subsystem performs searches using masked adjacency matrices that incorporate user permissions. When a user submits a search query, an access control masking subsystem applies a permission vector to mask prohibited records in adjacency data. This masking occurs during query time, rather than requiring index modifications when permissions change. In at least one embodiment, the masked adjacency matrix for a given user can be cached and only invalidated when the user permissions change or when the adjacency matrix of the graph index changes.

During search traversal, a system identifies candidate records by examining non-masked nodes adjacent to search nodes. If insufficient candidates are found, additional candidates may be identified through multi-hop traversal by, for example, examining nodes that are multiple steps away through the graph structure. This approach can maintain search quality while enforcing access controls.

At least one embodiment supports different search implementations. For dense vector collections, matrix multiplication operations can be used with permission vectors acting as masks. For graph-based indexes, traversal algorithms walk through permitted edges identified by masked adjacency matrices. Processing can be accelerated using GPUs, or other processors optimized for vector- or matrix-based operation, when appropriate based on data characteristics.

Permission vectors can be generated by combining access control data, representing group-level permissions, with user group membership data. The permission vectors for individual users can be cached and selectively invalidated when permissions change, avoiding unnecessary re-computation.

In at least one embodiment, the system maintains separation between index structures and access control data. When permissions change, only permission vectors need to be updated—the underlying indexes remain unchanged. This approach provides efficiency benefits for databases where permissions are frequently modified.

In at least one embodiment, matrix operations used in search and masking can be optimized based on data characteristics. Sparse matrix formats may be used when appropriate, and computations can be accelerated using GPU or other vector-optimized hardware processing when beneficial, based on matrix density and other factors.

At least one embodiment enables vector database systems to efficiently enforce access controls during search operations while maintaining search quality and performance. This can address the needs of applications in which both search capabilities and strict access control are required. At least some of the described approaches can support integration with various vector database implementations and can be applied in different deployment scenarios.

Described embodiments seek to provide technical solutions to one or more example technical problems, including for example the following.

First, vector databases face performance and maintenance challenges when implementing access control mechanisms. Some approaches to database record filtering may require either maintaining separate collections for different access permissions, performing a computationally expensive re-indexing of the database every time permissions change, performing pre-filtering before a computationally expensive brute-force search, or post-filtering results after search, which may return insufficient results. These approaches either reduce search efficiency or comprehensiveness or require complete re-indexing when permissions change. At least one embodiment seeks to address this by applying a permission vector to mask the adjacency matrix at query time, allowing efficient search traversal while maintaining access control without requiring index modifications when permissions change. In other embodiments, pre-filtering approaches to vector search described herein can be used to dramatically reduce the number of vector distance calculations required for a non-indexed brute-force search, thereby providing computationally efficient pre-filtered brute-force search techniques.

Second, vector search systems struggle to efficiently handle frequent permission changes in large-scale deployments. Existing solutions that enhance indexes with permission information require rebuilding indexes whenever access rights are modified, which is computationally expensive and impacts system availability. Example embodiments seek to address this by maintaining a separate permission management subsystem that generates and caches permission vectors, allowing permissions to be updated independently of the underlying index structure. When permissions change, only the affected user's permission vector needs to be invalidated and regenerated, while the graph index remains unchanged.

Third, implementing access control in vector search systems may involve compromising between search accuracy and computational efficiency. Example embodiments seek to provide an adaptive approach that can automatically select between different search strategies based on the characteristics of the masked adjacency matrix. For sparse permission scenarios, the system can switch to brute-force traversal of accessible records, while dense scenarios can leverage the masked graph index. The implementation can also take advantage of GPU acceleration for matrix operations when deemed to be beneficial based on computational efficiency metrics.

At least some of the technical solutions described herein maintain search quality while enforcing access control by allowing multi-hop traversal through prohibited nodes when necessary to reach additional authorized candidates, using an inverse permission vector to identify prohibited records adjacent to the search frontier and then finding authorized records connected through those nodes. This approach can be employed to ensure that the desired number of nearest neighbors can be found when possible, while still preventing access to unauthorized records.

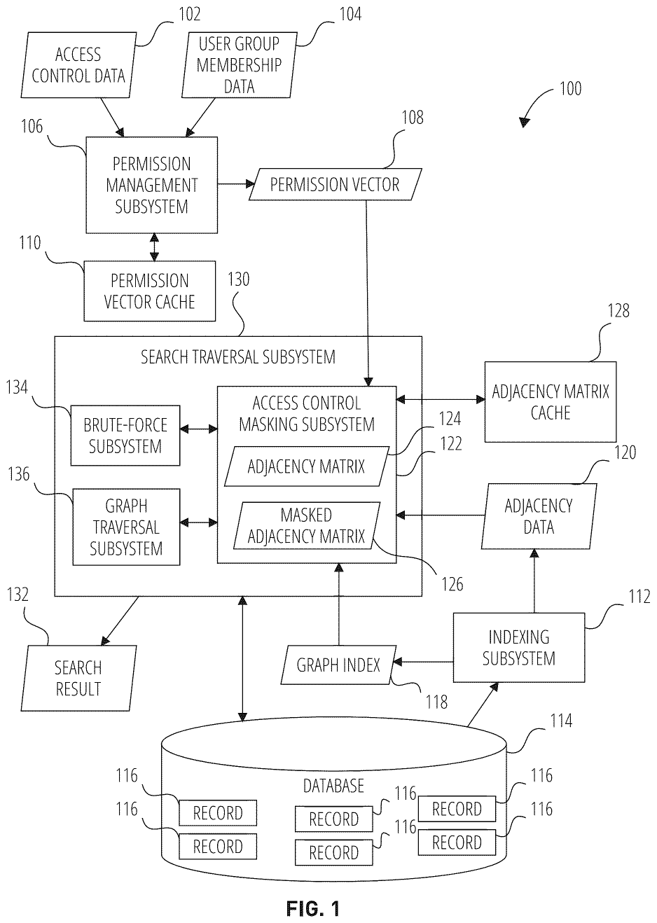

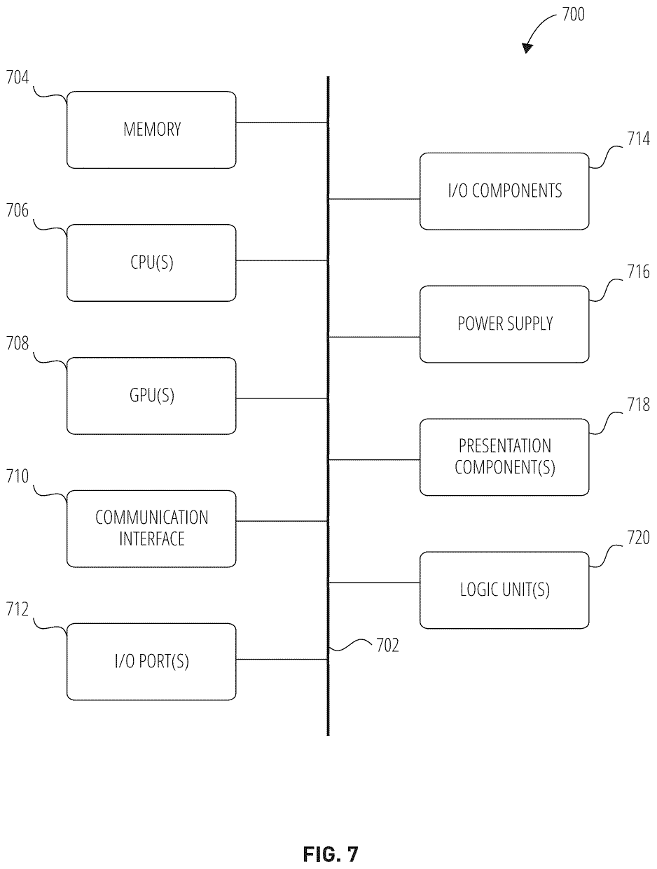

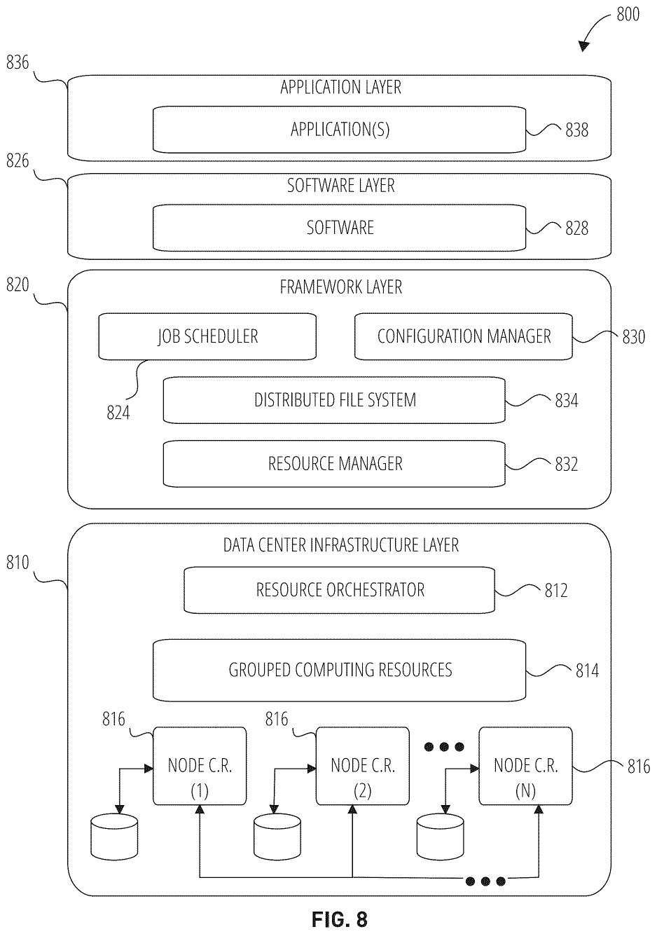

FIG. 1 is a block diagram illustrating a system 100 for controlling access to records during database search operations, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the systems and methods described herein may be implemented using one or more computing devices or components thereof (such as computing device 700 described with reference to FIG. 7) and/or one or more data centers or components thereof (such as data center 800 described with reference to FIG. 8).

In FIG. 1, access control data 102 and user group membership data 104 provide input to a permission management subsystem 106. The permission management subsystem 106 processes these data inputs to generate a permission vector 108, which indicates access rights for a user to records stored in a database 114. In some examples, the permission vector 108 is cached in a permission vector cache 110 to improve performance for subsequent access operations.

An indexing subsystem 112 interfaces with a database 114 containing multiple records 116. The indexing subsystem 112 generates a graph index 118 of the records 116 stored in the database 114; in at least one embodiment, the records 116 are represented by vector embeddings in a multi-dimensional space, and the graph index 118 is generated based on vector distances computed between the vector embeddings of the records 116, such that adjacent nodes in the graph index 118 correspond to vector embeddings having short distances, which may indicate semantic similarity and thereby enable efficient vector searching in a multi-dimensional semantic space.

In at least one embodiment, the indexing subsystem 112 also generates adjacency data 120 encoding edges between nodes of the graph index 118. The adjacency data 120 can be encoded in various formats, such as an adjacency list or an adjacency matrix 124 (described below). In an adjacency list, each node (corresponding to a record 116) has a list entry, and each list entry lists adjacent nodes. In an adjacency matrix 124, each row can correspond to a node, and the elements of a row can indicate the presence or absence of an edge indicating adjacency to another record corresponding to the columnar position of the element. Thus, each [i, j] element in the adjacency matrix 124 can indicate whether record i is adjacent to record j in the graph index 118.

A search traversal subsystem 130 performs search operations while respecting access control restrictions. The search traversal subsystem 130 generates a search result 132 containing only records that the user has permission to access.

In order to exclude prohibited records 116 from the search result 132, the search traversal subsystem 130 includes an access control masking subsystem 122. In at least one embodiment, the access control masking subsystem 122 receives the permission vector 108 and applies it to the adjacency matrix 124 representing the graph index 118. The adjacency matrix 124 may be the adjacency data 120 generated by the indexing subsystem 112, or may be generated by the access control masking subsystem 122 based on the adjacency data 120. The masking operation performed by the access control masking subsystem 122 generates a masked adjacency matrix 126 that masks access to prohibited records. The adjacency matrix 124 and/or the masked adjacency matrix 126 can be cached in an adjacency matrix cache 128 to improve performance.

In at least one embodiment, the access control masking subsystem 122 can first operate on the adjacency data 120 in a non-matrix format (such as an adjacency list) to generate the adjacency matrix 124 if the adjacency matrix 124 is not generated by the indexing subsystem 112. In at least one embodiment, the access control masking subsystem 122 (and/or other components of the system 100) can be configured to operate on matrix data in various formats, including compressed sparse matrix data, while preserving the original format.

In at least one embodiment, the access control masking subsystem 122 can perform masking using different approaches, instead of or in addition to the adjacency matrix masking operations described herein. These different approaches can include pre-filtering of the graph index 118, per-filtering of the records 116 of the database 114, and/or search runtime post-filtering of nearest-neighbor results in order to ensure that a sufficient number of results is returned.

In at least one embodiment, the search traversal subsystem 130 includes a brute-force subsystem 134 for performing brute-force searches of the records 116 of the database 114. Various brute-force search traversal techniques are described below. In at least some cases, the access control masking subsystem 122 uses the permission vector 108 to mask prohibited records 116 while the brute-force subsystem 134 performs the brute-force search.

In at least one embodiment, the search traversal subsystem 130 includes a graph traversal subsystem 136 for performing a traversal of the graph index 118, the adjacency matrix 124, and/or the masked adjacency matrix 126 to leverage index data to prioritize searching portions of the graph that are likely to be a close match to the search query. In at least one embodiment, the access control masking subsystem 122 masks the adjacency matrix 124 to generate the masked adjacency matrix 126, and the masked adjacency matrix 126 is traversed by the graph traversal subsystem 136 using a multi-hop traversal technique, as described in greater detail below. In at least one embodiment, the graph traversal subsystem 136 traverses the graph index 118 or the adjacency matrix 124 and uses the permission vector 108 or masked adjacency matrix 126 as a filter to exclude candidate records from the search result 132 during traversal, thereby ensuring that the search continues until a required number of non-prohibited records are included in the search result 132.

In some examples, the search traversal can adaptively switch between one or more graph-based and/or one or more brute-force approaches based on various factors, such as the sparsity of the masked adjacency matrix 126 or of the permission vector 108. For example, the search traversal subsystem 130 or the access control masking subsystem 122 can evaluate the sparsity of the masked adjacency matrix 126 to determine whether the masked adjacency matrix 126 (or, in some cases, the graph index 118 or the permission vector 108) exhibits a sparsity condition. In at least one embodiment, the sparsity condition can be detected based on a percentage or proportion of nodes (of the graph index 118 or masked adjacency matrix 126) that are prohibited, based on a total number of non-prohibited nodes, or one or more other metrics or criteria.

In at least one embodiment, the sparsity condition is determined by a search hyperparameter value. For example, the search traversal subsystem 130 can store a sparsity threshold hyperparameter that sets a threshold for the number of non-prohibited records in the database 114, such as 10,000 records; if the number of non-prohibited records is less than this value, the search traversal subsystem 130 uses the brute-force subsystem 134 to perform a brute-force search, otherwise the brute-force subsystem 134 is used for a graph traversal search. In another example embodiment, the graph search technique employed by the graph traversal subsystem 136 is limited to a predetermined number (defined by parameter “max_iteration”) of search iterations, and each iteration is expected to require the calculation of d distances between the search query and vector values corresponding to records 116 in the database 114, then the search traversal subsystem 130 may select a brute-force search performed by the brute-force subsystem 134 if the permission vector 108 includes fewer than (d x “max_iteration”) non-prohibited records, because it is expected that a graph traversal search by the graph traversal subsystem 136 would perform more distance calculations than a brute-force search. It will be appreciated that other sparsity conditions can be used in various embodiments to select between brute-force and graph traversal search operations in order to improve efficiency and/or comprehensiveness of the search.

In at least one embodiment, the search traversal subsystem 130 is configured to perform different search traversal operations, such as pre-filtered brute-force search traversal of the records 116 without reliance on a graph index 118. The search traversal subsystem 130 can use the permission vector 108 as a mask for a list or matrix of the records 116 to mask prohibited records, before calculating vector distances between a search query (converted to a vector embedding) and the embedding vectors corresponding to records 116. This pre-filtering operation can significantly reduce the number of vector distance calculations required prior to a search, particularly for sparse permission vectors 108 in which most of the records 116 are prohibited.

The system 100 can in at least one embodiment support both CPU and GPU acceleration of the matrix operations used for permission masking and search traversal. For example, the search traversal subsystem 130 can apply a computational efficiency metric to the masked adjacency matrix 126 to select between GPU-accelerated matrix operations and CPU operations for the search traversal. The computational efficiency metric can be based on a sparsity of the masked adjacency matrix 126: whereas a densely populated masked adjacency matrix 126 may be more efficiently traversed using a GPU (or other matrix-optimized processor), a more sparsely-populated masked adjacency matrix 126 may be more efficiently traversed by iterative, CPU-based operations, such as a brute-force search. In at least one embodiment, the computational efficiency metric can be based on expected levels of arithmetic intensity and/or data reuse of the selected search operation in the context of the user permissions applied to the database 114.

In at least one embodiment, the system 100 enables efficient vector search while enforcing access control by applying permissions at query time through matrix operations, avoiding the need to modify or rebuild indexes when permissions change.

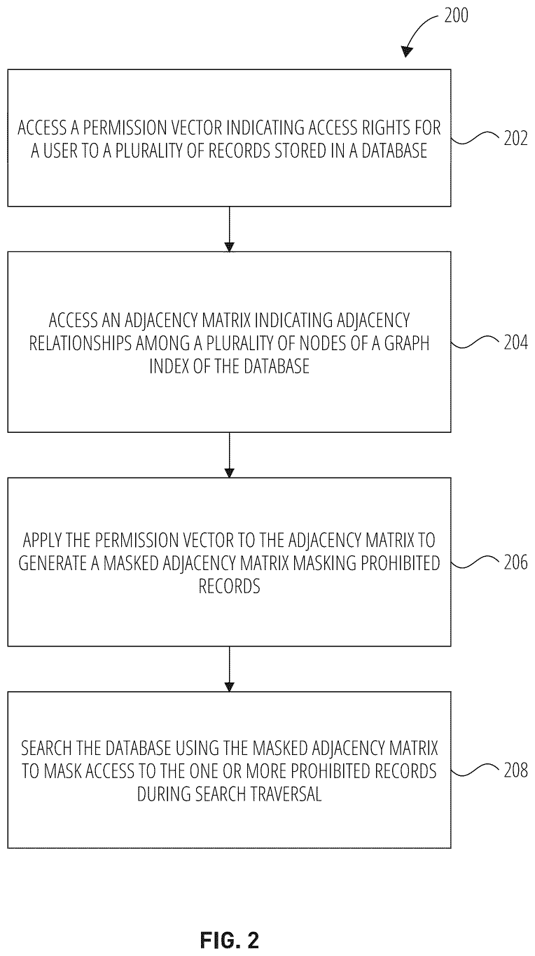

The operations of at least one embodiment of the system 100 are described in greater detail below with reference to FIG. 2.

FIG. 2 is a flowchart illustrating a method 200 for masking access to prohibited records during search traversal using a permission vector, in accordance with some embodiments of the present disclosure.

Each block of method 200, described herein, comprises a computing process that may be performed using any combination of hardware, firmware, and/or software. For instance, various functions may be carried out using one or more processors executing instructions stored in one or more memories. The method 200 may also be embodied as computer-usable instructions stored on computer storage media. The method 200 may be provided by a standalone application, by a service or hosted service (standalone or in combination with another hosted service), or as a microservice via an application programming interface (API) or a plug-in to another product, among other possible implementations. In addition, method 200 is described, by way of example, with respect to the system 100 of FIG. 1. However, this method 200 may additionally or alternatively be executed by any one system, or any combination of systems, including, but not limited to, those described herein.

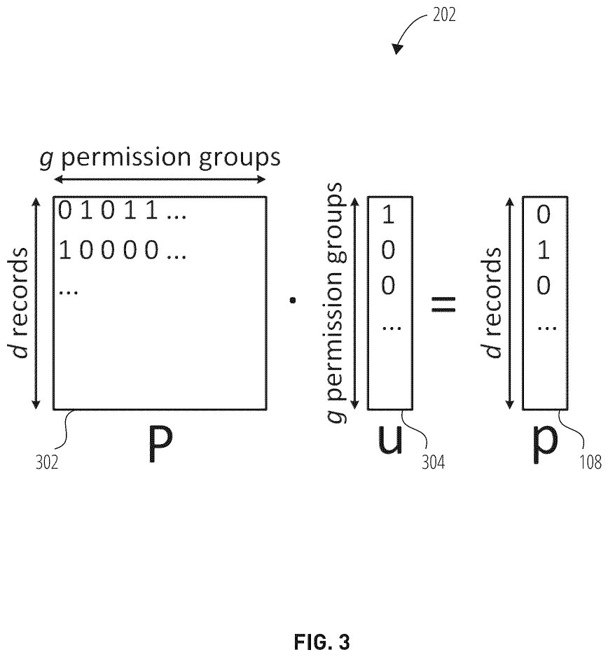

At operation 202, a permission vector 108, indicating access rights for a user to a plurality of records 116 stored in a database 114, is accessed. The permission vector 108 identifies prohibited records among the plurality of records 116 that the user is not authorized to access. In some examples, the permission vector 108 is generated by the permission management subsystem 106 by applying user group membership data 104 to access control data 102 to determine the user's access rights. An example of generating the permission vector 108 as part of operation 202 is described in detail below with reference to FIG. 3.

In at least one embodiment, as described above with reference to FIG. 1, the permission management subsystem 106 can receive or generate the permission vector 108 and store the permission vector 108 in a permission vector cache 110 for later retrieval and re-use if the user's permissions have not changed. For example, if the permission management subsystem 106 receives updated access control data 102 or updated user group membership data 104 that affects a given user's permissions, then the cached permission vector 108 for that user can be invalidated, thereby requiring the permission management subsystem 106 to re-generate the permission vector 108 from the current access control data 102 and user group membership data 104.

At operation 204, an adjacency matrix 124 indicating adjacency relationships among a plurality of nodes of a graph index 118 of the database 114 is accessed. As described above, each node of the plurality of nodes corresponds to a record of the plurality of records 116. In at least one embodiment, the adjacency relationships are determined based on a vector similarity measure (such as vector distance) between records 116 represented as vectors, such as vector embeddings of documents.

In at least one embodiment, the adjacency matrix 124 is generated by the indexing subsystem 112 along with the graph index 118. In at least one embodiment, the adjacency matrix 124 is generated by the access control masking subsystem 122 by processing adjacency data 120 (such as an adjacency list) generated by the indexing subsystem 112. In at least one embodiment, as described above, the access control masking subsystem 122 can store the generated adjacency matrix 124 in the adjacency matrix cache 128 for later retrieval and re-use if the graph index 118 has not changed. The access control masking subsystem 122 can access the generated (or cached) adjacency matrix 124 and the generated (or cached) permission vector 108 to perform the masking operation 206.

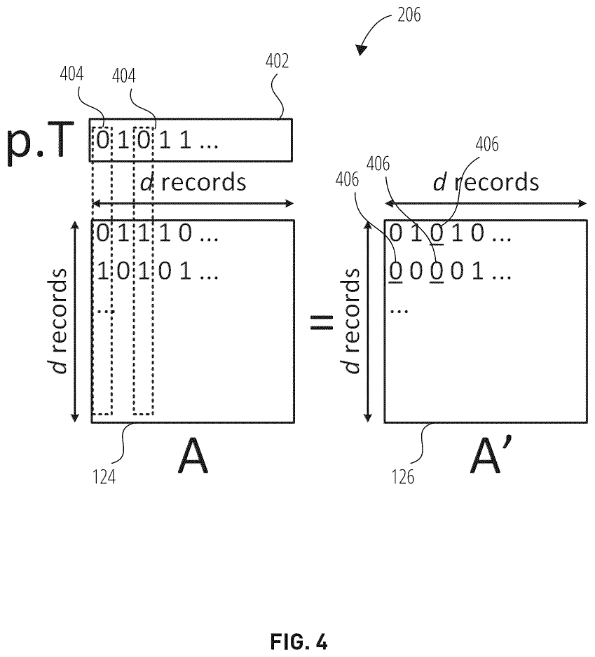

At operation 206, the permission vector 108 is applied to the adjacency matrix 124 to generate a masked adjacency matrix 126 masking prohibited records. Operation 206 can be performed by the access control masking subsystem 122 of the system 100, using the permission vector 108 and adjacency matrix 124 as inputs, and generating the masked adjacency matrix 126 as an output. The masked adjacency matrix 126 masks adjacency relationships with nodes corresponding to records that the user is not authorized to access. In at least one embodiment, this operation 206 involves applying an element-wise AND operation or a similar masking operation to the permission vector 108 and each row of the adjacency matrix 124 to generate the masked adjacency matrix 126. An example of operation 206 is described in detail below with reference to FIG. 4.

In at least one embodiment, as described above, the access control masking subsystem 122 can store the masked adjacency matrix 126 in the adjacency matrix cache 128 for later retrieval and re-use if the user's permission vector 108 and the graph index 118 have not changed.

At operation 208, the database 114 is searched using the masked adjacency matrix 126 to mask access to prohibited records during search traversal. Operation 208 can be performed by the search traversal subsystem 130, by traversing the graph index 118 using the permission vector 108 and/or the masked adjacency matrix 126 as inputs. In at least one embodiment, the search traversal subsystem 130 uses the permission vector 108 and/or masked adjacency matrix 126 to mask records 116 of the database 114 itself while performing the traversal. The search traversal uses the masked adjacency matrix 126 (or, in some embodiments, the permission vector 108) to identify candidate records while preventing access to unauthorized records. In at least one embodiment, the search traversal can adaptively switch between graph-based and brute-force approaches based on the sparsity characteristics of the masked adjacency matrix 126. In at least one embodiment, the search traversal can adaptively switch between CPU-based on GPU-based search processing based on a computational efficiency metric computed based on the sparsity characteristics of the masked adjacency matrix 126.

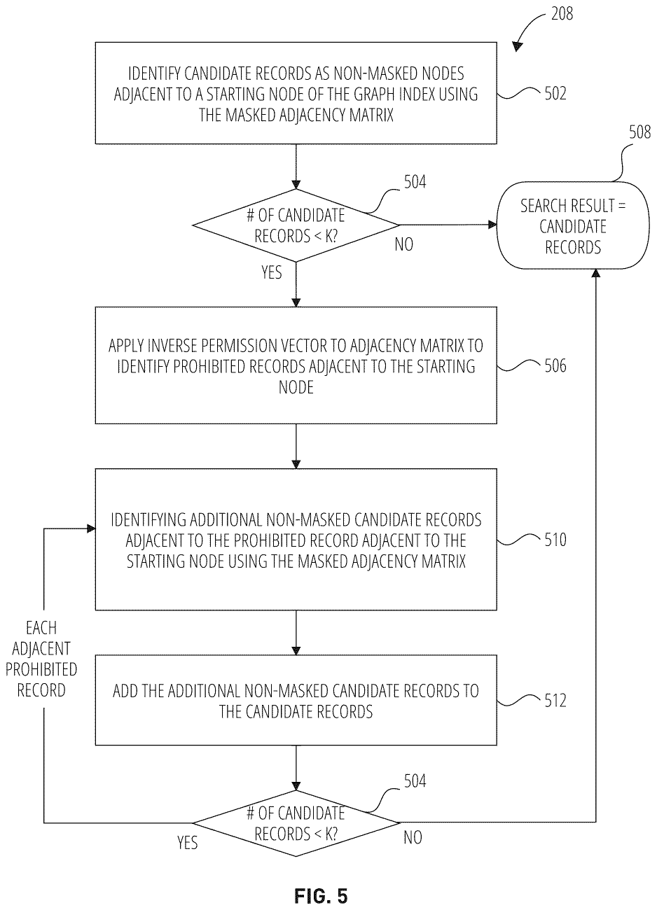

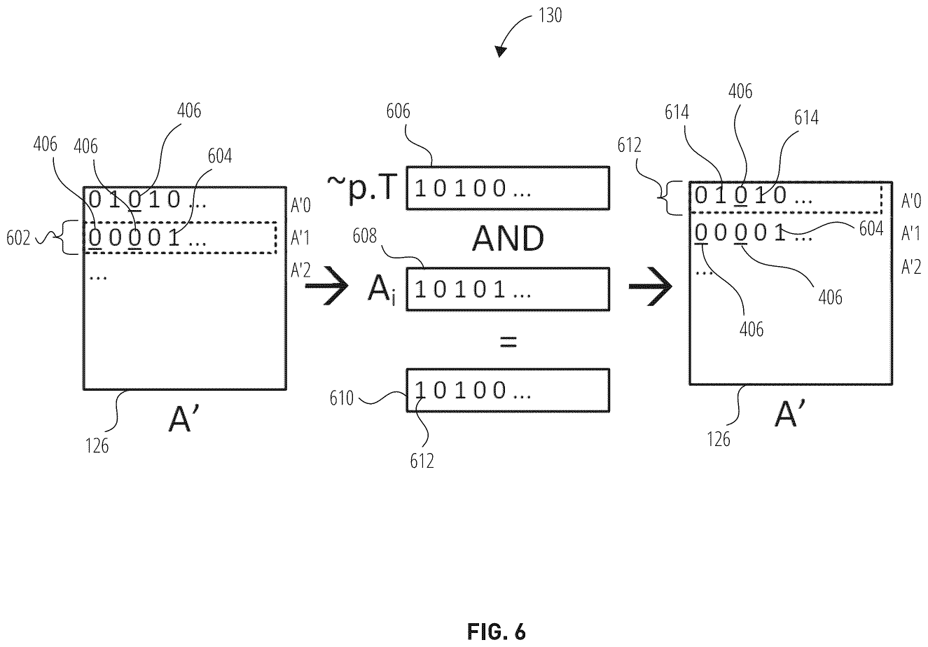

In at least one embodiment, the search traversal operation 208 uses a multi-hop traversal in which prohibited nodes in the graph index can still be traversed to find nearby nodes. An example of multi-hop search traversal in operation 208 is described in detail below with reference to FIG. 5 and FIG. 6.

In at least one embodiment, the system 100 can support multiple search techniques beyond the multi-hop graph traversal approach, such that the system 100 selects among multiple possible techniques for performing operation 208. In some cases, when the masked adjacency matrix 126 is highly sparse due to restrictive permissions, the system 100 can perform a brute-force traversal of the non-prohibited records at operation 208. This brute-force approach can involve computing vector distances between a query vector and only those vectors that the user has permission to access, as determined by the permission vector 108.

At least one embodiment can use dense matrix multiplication (DMM) to perform these distance calculations. In DMM scenarios, the permission vector 108 can be used as a pre-filter to skip unnecessary distance computations between vectors. This can involve using an SDDMM (Sampled Dense-Dense Matrix Multiplication) primitive feature of a GPU or other processor that allows specifying a mask to compute distances only between authorized (non-prohibited) vectors. The mask essentially says “only compute these distances” rather than performing exhaustive computations between all vectors. This approach can provide significant computational benefits by avoiding distance calculations for vectors corresponding to prohibited records.

In at least one embodiment, the search traversal subsystem 130 can adaptively select between different computational approaches based on the characteristics of the masked adjacency matrix 126. For example, when the permission vector 108 is relatively dense, the search traversal subsystem 130 can use dense matrix operations optimized for GPU acceleration. When the permission vector 108 is sparse, the search traversal subsystem 130 can leverage compressed sparse formats and specialized sparse matrix operations. This flexibility may allow the system 100 to maintain efficiency across different access control patterns while still preventing access to unauthorized records. In at least one embodiment, the system 100 can determine whether to use brute-force traversal or graph-based approaches by evaluating computational efficiency metrics based on the sparsity of the masked adjacency matrix 126.

In at least one example, as described above, the system 100 can determine specific metrics and thresholds for adaptively selecting between different computational approaches based on the sparsity characteristics of the masked adjacency matrix 126. The search traversal subsystem 130 can evaluate the density or sparsity of non-zero elements in the masked adjacency matrix 126 to determine whether to use graph-based traversal or fall back to brute-force scanning of accessible records. When the permission vector 108 is highly selective, creating a very sparse masked adjacency matrix 126 where valid nodes are widely separated, the system 100 can determine that traversing multiple hops through the graph index would require excessive computational effort compared to directly scanning the permitted vectors. The system 100 can calculate a computational efficiency metric based on factors like the ratio of non-prohibited nodes to prohibited nodes, the average path length required to reach non-prohibited nodes through multi-hop traversal, and the relative performance characteristics of GPU-accelerated matrix operations versus CPU-based scanning operations. These metrics allow the system to automatically select the most efficient computational approach, such as using GPU-accelerated graph traversal for dense permission scenarios, while switching to CPU-based brute force operations when the sparsity of permissions would make graph traversal inefficient.

In at least one embodiment, the method 200 enables efficient vector search while enforcing access control by applying permissions at query time, avoiding the need to modify or rebuild indexes when permissions change.

FIG. 3 is a diagram illustrating generation of a permission vector 108 from access control data 302 and user group membership data 304. The operation shown in FIG. 3 is an example implementation of operation 202 of FIG. 2, in which accessing the permission vector 108 includes generation of the permission vector 108 before it is accessed. The generated permission vector 108 can be accessed directly after generation, or it can be stored in the permission vector cache 110 and accessed later.

The access control data 302 is shown as an access control matrix P, representing access rights for g permission groups to d records 116 stored in the database 114. The access control matrix P has dimensions d×g, where each row corresponds to a record and each column corresponds to a permission group. The value at [row i, column j] is 1 if permission group j is authorized to access document i, and 0 if not.

The user group membership data 304 is shown as a user access vector u, indicating the membership status of a user in each of the g permission groups. The user access vector u has dimensions g×1, with binary values indicating whether the user belongs to each permission group: a 1 value at [i] indicates membership of the user in permission group i, and a 0 indicates non-membership.

The permission vector 108, denoted p, is generated by multiplying the access control matrix P, corresponding to the access control data 302, by the user access vector u, corresponding to the user group membership data 304. The resulting permission vector 108 p has dimensions d×1, with binary values indicating whether the user has access rights to each of the d records: a 1 value at [i] indicates that the user has access to record i, and a 0 indicates that record i is prohibited to the user.

In at least one embodiment, the permission vector 108 p serves as input to the access control masking subsystem 122 described above. An example of the masking operation 206 performed by the access control masking subsystem 122 is now described with reference to FIG. 4.

FIG. 4 is a diagram illustrating an example application of a permission vector 108 to an adjacency matrix 124 to generate a masked adjacency matrix 126. The operation shown in FIG. 4 is an example implementation of operation 206 of FIG. 2.

A transpose of the permission vector 108 is shown as transpose permission vector 402, denoted p.T. The transpose permission vector 402 is applied to an adjacency matrix 124, denoted A, to generate a masked adjacency matrix 126, denoted A′. The adjacency matrix 124 has dimensions d×d, continuing the example shown in FIG. 3.

The transpose permission vector 402 is a transpose of the permission vector 108, and therefore contains the same binary values as the permission vector 108 indicating access permissions of the user for each record. When applied to each row of the adjacency matrix 124 in a masking operation, the transpose permission vector 402 masks those columns corresponding to prohibited records, which are shown as masked columns 404 corresponding to the 0 values of the transpose permission vector 402. In some examples, the masking operation involves an element-wise or bit-wise multiplication operation or a Boolean AND operation between the transpose permission vector 402 and each row of the adjacency matrix 124.

The resulting masked adjacency matrix 126 contains masked adjacency relationships 406 where prohibited records have been masked out (shown as underlined 0 values). Each row i in the masked adjacency matrix 126 indicates the non-prohibited adjacent neighbors of a node in the graph index corresponding to the i^{th} record, with 0 values in positions corresponding to prohibited records. Thus, each element at [row i, column j] in the masked adjacency matrix 126 indicates whether the ith record is adjacent to a non-prohibited record j. If the node corresponding to the jth record is not adjacent to the node corresponding to record i in the graph index, or if record j is prohibited, then the value is 0.

In at least one embodiment, the masked adjacency matrix 126 is stored in a compressed sparse format to improve computational efficiency.

The example of operation 206 shown in FIG. 4 transforms the original adjacency relationships of the adjacency data 120 and adjacency matrix 124 into permission-aware relationships that prevent traversal to prohibited records during search operations. This masking approach enables efficient search, including vector search, while maintaining access control, without requiring modifications to the underlying graph index when permissions change.

FIG. 5 is a flowchart illustrating an example implementation of the search traversal operation 208 of FIG. 2, in which candidate records for possible inclusion in a search result are identified using a masked adjacency matrix 126 and multi-hop traversal of the graph index 118, as represented by the adjacency matrix 124. In at least one embodiment, as described above, the operation 208 can be performed by the search traversal subsystem 130 of the system 100.

The operations shown in FIG. 5 are described with reference to FIG. 6, which illustrates an example of matrices, vectors, and values that can be processed according to these operations.

At operation 502, candidate records are identified as non-masked nodes adjacent to a starting node of the graph index 118 using the masked adjacency matrix 126. The non-masked nodes correspond to records 116 that are not prohibited records based on user access permissions. As shown in FIG. 6, the starting node 602 is represented as the second row in the masked adjacency matrix 126, and can be designated A′₁, with the understanding that the masked adjacency matrix 126 begins at row A′₀. This starting node 602 can represent a starting point for traversal of the graph index 118. In at least one embodiment, the search traversal operation 208 can be performed in series and/or in parallel for multiple starting nodes, or for a single starting node, according to vector search graph traversal techniques.

The values shown for the starting node 602 in the masked adjacency matrix 126 include at least two masked adjacency relationships 406, as previously described with reference to FIG. 4. These masked adjacency relationship 406 correspond to nodes adjacent to the starting node 602 in the graph index 118, but which are prohibited to the user based on the user's permissions.

Because of the masked adjacency relationships 406 in the starting node 602, the starting node 602 in the masked adjacency matrix 126, A′₁, includes only a single 1 value element, at the fifth column (and so corresponding to the fifth record), corresponding to a single non-prohibited adjacent node in the graph index 118. This single 1 record is designated as a first candidate record 604 during operation 502. (For the purpose of simplicity, it is assumed that the remaining values of the starting node 602 elided by the ellipsis, “. . . ”, are all 0 values.) Accordingly, at the end of operation 502, the number of candidate records is one: the fifth record 116, corresponding to the fifth entry in the masked adjacency matrix 126 for the starting node 602.

At operation 504, a determination is made whether the current number of candidate records is less than a threshold number k. The threshold number represents a minimum number of records that are to be returned in a search result. Thus, at operation 504, if the number of candidate records equals or exceeds k, the method proceeds to output search result 508, where the search result is set to include the identified candidate records.

However, if the number of candidate records is less than k, as in the example shown in FIG. 6 (where k is assumed to be equal to 2 for simplicity), the method proceeds to operation 506, in order to begin a multi-hop traversal of prohibited nodes in the graph index 118. The example illustrated in FIG. 5 shows a two-hop traversal, but some embodiments can repeat the operations shown in FIG. 5 to perform one or more additional hops across prohibited nodes.

At operation 506, an inverse of the permission vector 606 (designated ~p.T in FIG. 6) is applied to the original, non-masked adjacency matrix 124 to identify prohibited records adjacent to the starting node 602. The inverse of the permission vector 606 is a version of the transpose permission vector 402 in which each 1 value is replaced with a 0 and vice-versa. The inverse of the permission vector 606 is applied to the same starting node 602 of the adjacency matrix 124, shown as starting node in the adjacency matrix 608 and designated Aᵢ in FIG. 6. However, in the continuing example, it will be appreciated that Aᵢ is A₁ in this case. The same masking operation used in FIG. 4, such as a multiplication or Boolean AND operation, is applied to the inverse of the permission vector 606 and the starting node in the adjacency matrix 608 (designated Aᵢ, corresponding to the second row of the matrix, A₁, in this example) to generate a vector of adjacent prohibited records 610 identifying prohibited nodes adjacent to the starting node 602. The 1 values appearing in the adjacent prohibited records 610 (such as the first adjacent prohibited record 612) correspond to those nodes adjacent to starting node 602 which were masked out in the masked adjacency matrix 126, but which can now be traversed to find additional non-prohibited candidate nodes.

At operation 510, for each prohibited record identified in operation 506, such as first adjacent prohibited record 612, additional non-masked candidate records adjacent to that prohibited record are identified using the masked adjacency matrix 126. Thus, as shown in FIG. 6, the first adjacent prohibited record 612 is at the first column of the adjacent prohibited records 610, corresponding to the first row of the masked adjacency matrix 126. In the masked adjacency matrix 126, the first adjacent prohibited record 612 (designated row A′₀) indicates two adjacent non-prohibited additional candidate records 614, at the second column and the fourth column. The additional candidate record 614 at the second column is simply the adjacency relationship back to the starting node 602, which is the second record. However, the additional candidate record 614 at the fourth column indicates another, as-yet-untraversed record in the masked adjacency matrix 126, which is adjacent to a node (first adjacent prohibited record 612) that is adjacent to the starting node 602, and which is not prohibited to the user.

At operation 512, the additional non-masked candidate records identified in operation 510 are added to the set of candidate records. Thus, the search traversal subsystem 130 can add the record corresponding to the new node discovered at operation 510 (the additional candidate record 614 at the fourth column) to the cumulative set of candidate records, such that the current set of candidate records includes both the first candidate record 604 corresponding to the fifth column and the additional candidate record 614 corresponding to the fourth column.

The method then repeats operation 504 to check if the updated number of candidate records meets or exceeds the threshold number k. In this simplified example, k=2, and so the second repetition of operation 504 results in determining that the number of candidate records is not less than the threshold number, causing the method to return the search result 508 as the set of candidate records, namely, the fourth and fifth records (first candidate record 604 and additional candidate record 614) in the continuing example of FIG. 6. However, if k were set to a number higher than 2, the method would return to operation 510 to traverse a second prohibited node adjacent to the starting node 602. In the examples of FIG. 6, the adjacent prohibited records 610 included a second 1 value, at the third column: thus, the method would return to operation 510 to traverse the node at the third row of the adjacency matrix 124 and masked adjacency matrix 126, repeating operation 510 and operation 512 at A′₂ instead of A′₀.

Thus, the method continues iterating through operation 510 and operation 512 for each adjacent prohibited record in the adjacent prohibited records 610 until either k candidate records are identified or all possible paths through prohibited records have been explored. This approach enables efficient vector search with access control by allowing controlled traversal through prohibited nodes when necessary to reach the desired number of authorized results, and without revealing any information about the prohibited nodes.

In at least one embodiment, a set of more than k candidate records can be sorted or narrowed down to the k nearest neighbors of the search query in order to generate the final search result 508. Vector distances are calculated between a query vector representation of the search query and the vector representation of each candidate record. In at least one embodiment, these vector distance calculations can be performed using dense matrix multiplication operations optimized for GPU acceleration. A similarity metric, such as vector proximity or distance measures, is then applied to rank the candidate vectors based on their semantic similarity to the query vector. The search traversal subsystem 130 may adaptively select between different computational approaches based on characteristics of the masked adjacency matrix 126: for dense permission scenarios, GPU-accelerated matrix operations can be used to efficiently compute distances between vectors, while sparse scenarios may use CPU-based operations.

### Example Computing Device

FIG. 7 is a block diagram of an example computing device 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device 700 may comprise one or more virtual machines (VMs), and/or any of the components thereof may comprise virtual components (e.g., virtual hardware components). For non-limiting examples, one or more of the GPU(s) 708 may comprise one or more vGPUs, one or more of the CPU(s) 706 may comprise one or more vCPUs, and/or one or more of the logic unit(s) 720 may comprise one or more virtual logic units. As such, a computing device 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPU(s) 708, the CPU(s) 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 706 may be directly connected to the memory 704. Further, the CPU(s) 706 may be directly connected to the GPU(s) 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPU(s) 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic unit(s) 720 may be part of and/or integrated in one or more of the CPU(s) 706 and/or the GPU(s) 708 and/or one or more of the logic unit(s) 720 may be discrete components or otherwise external to the CPU(s) 706 and/or the GPU(s) 708. In embodiments, one or more of the logic unit(s) 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, including wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O port(s) 712 may allow the computing device 700 to be logically coupled to other devices including the I/O components 714, the presentation component(s) 718, and/or other components, some of which may be built in to (e.g., integrated in) the computing device computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may include one or more depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiment of the present disclosure. The data center 800 may include a data center infrastructure layer 810, a framework layer 820, a software layer 826, and/or an application layer 836.

As shown in FIG. 8, the data center infrastructure layer 810 may include a resource orchestrator 812, grouped computing resources 814, and node computing resources 816 (“node C.R. s”), shown as (1)−(N), where “N” represents any whole, positive integer. In at least one embodiment, node computing resources 816 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among node computing resources 816 may correspond to a server having one or more of the above-mentioned computing resources. In addition, in some embodiments, the node computing resources 816 may include one or more virtual components, such as vGPUs, vCPUs, and/or the like, and/or one or more of the node computing resources 816 may correspond to a virtual machine (VM).

In at least one embodiment, grouped computing resources 814 may include separate groupings of node computing resources 816 housed within one or more racks (not shown), or many racks housed in data centers at various geographical locations (also not shown). Separate groupings of node computing resources 816 within grouped computing resources 814 may include grouped compute, network, memory or storage resources that may be configured or allocated to support one or more workloads. In at least one embodiment, several node computing resources 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node computing resources 816 and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 824, a configuration manager 830, a resource manager 832, and/or a distributed file system 834. The framework layer 820 may include a framework to support software 828 of software layer 826 and/or one or more application(s) 838 of application layer 836. The software 828 or application(s) 838 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 834 for large-scale data processing (e.g., “big data”). In at least one embodiment, job scheduler 824 may include a Spark driver to facilitate scheduling of workloads supported by various layers of data center 800. The configuration manager 830 may be capable of configuring different layers such as software layer 826 and framework layer 820 including Spark and distributed file system 834 for supporting large-scale data processing. The resource manager 832 may be capable of managing clustered or grouped computing resources mapped to or allocated for support of distributed file system 834 and job scheduler 824. In at least one embodiment, clustered or grouped computing resources may include grouped computing resources 814 at data center infrastructure layer 810. The resource manager 832 may coordinate with resource orchestrator 812 to manage these mapped or allocated computing resources.

In at least one embodiment, software 828 included in software layer 826 may include software used by at least portions of node computing resources 816, grouped computing resources 814, and/or distributed file system 834 of framework layer 820. One or more types of software may include, but are not limited to, Internet web page search software, e-mail virus scan software, database software, and streaming video content software.

In at least one embodiment, application(s) 838 included in application layer 836 may include one or more types of applications used by at least portions of node computing resources 816, grouped computing resources 814, and/or distributed file system 834 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 830, resource manager 832, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device 700 of FIG. 7—e.g., each device may include similar components, features, and/or functionality of the computing device 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” and/or “operation” may be used herein to connote different elements of methods employed, the terms should not be interpreted as implying any particular order among or between various steps herein disclosed unless and except when the order of individual steps is explicitly described.

As described above, in at least one example, techniques described herein can leverage tensor cores and/or other specialized hardware accelerators to optimize the permission vector generation operations and adjacency matrix masking operations during search traversal. When generating the permission vector 108 at the permission management subsystem 106, matrix multiplication operations between the access control matrix P and the user access vector u (shown in FIG. 3) can be accelerated using tensor cores optimized for dense matrix operations. The access control masking subsystem 122 can also utilize tensor cores or other accelerator hardware to efficiently apply the permission vector 108 to the adjacency matrix 124 through optimized matrix masking operations. During search traversal, the search traversal subsystem 130 can adaptively select between different computational approaches: for dense permission scenarios, tensor core acceleration can be used for efficient matrix operations on the masked adjacency matrix 126, while sparse scenarios may use CPU-based operations. The system 100 can also leverage tensor cores or other accelerator hardware for accelerating distance calculations between vectors when performing dense matrix multiplication operations during brute-force traversal. This hardware acceleration approach allows the system 100 to maintain computational efficiency while enforcing access controls, particularly for dense permission scenarios where matrix operations can benefit from specialized tensor processing capabilities.

In at least one embodiment, the system 100 can operate with encrypted vector representations in a confidential computing environment while maintaining access control functionality. When using encrypted vectors, the permission vector 108 can be applied to mask access without requiring decryption of the underlying vector data, enabling efficient search while preserving data confidentiality. The search traversal subsystem 130 can perform distance calculations between encrypted vectors in a confidential computing environment, where the masked adjacency matrix 126 ensures that only permitted vectors are loaded for comparison. This approach reduces the complexity of confidential computing requirements, because the system only needs to load and process vectors that match the permission vector 108, rather than requiring access to the complete encrypted dataset. The masking operation can be performed within a confidential computing GPU or other secure processing environment, allowing the system to maintain both access control restrictions and data encryption throughout the search process. By integrating access control at the masking layer, the system can support confidential computing scenarios without requiring modifications to the underlying encrypted vector representations or graph index structures.

In at least one embodiment, the masking approach described herein can be integrated with existing vector database implementations and APIs through pre-filtering mechanisms. Some existing vector database systems support pre-filtering as a feature, where a bit set or mask can be applied before performing vector similarity searches. The permission vector 108 can be implemented as a pre-filter mask that integrates with these existing pre-filtering APIs, allowing the access control mechanism to work with established vector database systems without requiring modifications to their core indexing functionality. The system 100 described herein can leverage existing pre-filtering implementations for various operations, such as deleting vectors through tombstoning and hybrid structured/unstructured search, while extending these mechanisms to handle access control permissions. When implemented with graph-based indexes such as CAGRA (Concurrent Asynchronous Graph Augmented), the permission vector-based mask can be applied through the pre-filtering APIs to mask nodes during graph traversal. The masking approach can also integrate with dense matrix multiplication primitives such as SDDMM that support mask-based computation, enabling efficient implementation of permission-based filtering within existing vector database architectures. This integration can facilitate integration of described examples with vector database providers to incorporate the described access control techniques while maintaining compatibility with existing APIs and taking advantage of already-implemented pre-filtering optimizations.

As mentioned above, in at least one example, the system 100 can implement described techniques within a graph-based algorithm called CAGRA (Clustered Approximate Graph-based Accelerated search) to apply pre-filtering during vector search operations. In at least one embodiment, a CAGRA implementation can be provided that uses a flat graph structure with a hash table to track visited nodes during traversal, enabling efficient application of the permission vector-based mask while maintaining search performance. When performing graph traversal with CAGRA, the system 100 can apply the permission vector as a pre-filter mask to prevent traversal to unauthorized nodes, while using the hash table to avoid revisiting nodes that have already been explored. Such embodiments can potentially support both dense and sparse permission scenarios: for dense permissions, the system 100 can leverage GPU-accelerated matrix operations, while sparse scenarios may use CPU-based operations optimized for the specific graph structure. The CAGRA algorithm can incorporate specialized techniques for handling pre-filtering with very sparse permission vectors, including methods as described herein to efficiently traverse the flat graph structure while honoring access control restrictions. Some such embodiments may allow the system 100 to maintain the performance benefits of CAGRA's graph-based search while adding access control through pre-filtering, without requiring modifications to indexing functionality.

The described masking technique can be implemented in various applications and contexts beyond vector search of a vector database using a graph index. As described above, in dense matrix multiplication scenarios, the permission vector can be used as a pre-filter to skip unnecessary distance computations, leveraging GPU acceleration for efficient matrix operations. In at least one embodiment, the system 100 can adaptively switch between different computational approaches: for example, using dense matrix operations when the permission mask is relatively dense, or sparse matrix formats and operations when the mask is sparse, optimizing performance based on access control patterns. This flexibility can allow the technique to be efficiently implemented across different hardware architectures and computational frameworks while maintaining the security guarantees of the access control system.

In at least one embodiment, the described techniques can be applied to social network graph traversal and recommendation systems, where access control is critical for protecting user privacy. For example, in social networks where users have different visibility permissions for different connection levels (friends, friends-of-friends, etc.), the permission vector can mask the adjacency matrix representing the social graph during traversal operations. The multi-hop traversal capability can be used to discover permitted connections through intermediate nodes while maintaining access control restrictions. These techniques can also be applied to enterprise knowledge graphs, where different users or groups have varying levels of access to different types of connected information.

Various different embodiments can be provided to handle different scaling requirements and access control patterns. For high-throughput systems, the permission vector cache 110 and/or the adjacency matrix cache 128 can be distributed across multiple nodes of a data center or networked computing environment, with local caching of frequently accessed permission patterns and/or adjacency data. The adjacency matrix itself can be stored in various formats: for example, dense representation for smaller graphs, compressed sparse formats for large-scale systems, or hybrid approaches that optimize for specific access patterns. When implemented in GPU-accelerated systems, the masking operations can take advantage of tensor core acceleration for the permission vector generation and/or the masked matrix operations during search traversal. In at least one embodiment, the system can also integrate with existing authentication and authorization frameworks by translating their access control policies into the permission vector format at query time.

### EXAMPLES

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is one or more processors comprising processing circuitry to perform operations comprising: accessing a permission vector indicating access rights for a user to a plurality of records stored in a database, the access rights indicating one or more prohibited records of the plurality of records; and searching the database using the permission vector to mask access to the one or more prohibited records during search traversal.

In Example 2, the subject matter of Example 1 includes, wherein: the records comprise vectors; and the searching of the database comprises a vector search operation.

In Example 3, the subject matter of Example 2 includes, wherein: the searching of the database using the permission vector to mask access to the one or more prohibited records during search traversal comprises: accessing an adjacency matrix indicating adjacency relationships among a plurality of nodes of a graph index of the database, each node of the plurality of nodes corresponding to a record of the plurality of records; applying the permission vector to the adjacency matrix to generate a masked adjacency matrix in which adjacency relationships with nodes corresponding to the prohibited records are masked; and searching the database using the masked adjacency matrix to mask access to the one or more prohibited records during search traversal.

In Example 4, the subject matter of Example 3 includes, wherein the operations further comprise: accessing access control data representing access rights of a plurality of access groups to the plurality of records; accessing user group membership data indicating membership of the user in one or more access groups of the plurality of access groups; and generating the permission vector by applying the user group membership data to the access control data.

In Example 5, the subject matter of Example 4 includes, wherein the operations further comprise: storing a plurality of permission vectors for a plurality of users; detecting a change in access rights for at least one user of the plurality of users; and invalidating only the stored permission vector for the at least one user whose access rights changed.

In Example 6, the subject matter of Examples 3-5 includes, wherein the operations further comprise: determining whether the masked adjacency matrix satisfies a sparsity condition; and based on whether the masked adjacency matrix satisfies the sparsity condition, either: performing the search traversal as a brute-force traversal of the plurality of records; or performing the search traversal as a traversal of the graph index.

In Example 7, the subject matter of Examples 3-6 includes, wherein the operations further comprise: determining a computational efficiency metric based on a sparsity of the masked adjacency matrix; and selecting hardware-accelerated matrix operations for the search traversal based on the computational efficiency metric.

In Example 8, the subject matter of Examples 3-7 includes, wherein: the adjacency matrix is stored in a compressed sparse format; and the search traversal is performed using sparse matrix multiplication operations optimized for the compressed sparse format.

In Example 9, the subject matter of Examples 3-8 includes, wherein the operations further comprise: in response to a change in the access rights for the user to the plurality of records: updating the permission vector; and not changing the adjacency matrix.

In Example 10, the subject matter of Examples 2-9 includes, wherein: the search traversal comprises brute-force traversal of the plurality of records.

In Example 11, the subject matter of Example 10 includes, wherein: the records comprise vectors; and the brute-force traversal of the plurality of records comprises: performing a dense matrix multiplication operation using the permission vector to compute vector distances only between records that satisfy the access rights.

In Example 12, the subject matter of Examples 3-11 includes, wherein: the search traversal comprises traversal of the graph index.

In Example 13, the subject matter of Example 12 includes, wherein: the traversal of the graph index comprises: accessing a search query; traversing the graph index, using the masked adjacency matrix to mask access to the one or more prohibited records, to identify a plurality of candidate records; and generating a search result comprising one or more records selected from the plurality of candidate records by applying a similarity metric.

In Example 14, the subject matter of Example 13 includes, wherein: the traversing of the graph index comprises: identifying a first number of candidate records as non-masked nodes adjacent to a starting node of the graph index using the masked adjacency matrix, the non-masked nodes corresponding to records that are not prohibited records; determining that the first number is less than a threshold number of candidate records; applying an inverse of the permission vector to the adjacency matrix to identify the prohibited records adjacent to the starting node; and for each of one or more of the prohibited records adjacent to the starting node: identifying one or more additional non-masked candidate records adjacent to the prohibited record adjacent to the starting node using the masked adjacency matrix; and identifying the plurality of candidate records as the first number of candidate records and the one or more additional non-masked candidate records.

In Example 15, the subject matter of Example 14 includes, wherein: the records comprise vectors; and the similarity metric comprises a vector proximity measure.

In Example 16, the subject matter of Example 15 includes, wherein: the adjacency relationships of the adjacency matrix are determined based on vector proximity between the records corresponding to the nodes.

Example 17 is a system comprising one or more processors to perform operations comprising: accessing a permission vector indicating access rights for a user to a plurality of records stored in a database, the access rights indicating one or more prohibited records of the plurality of records; and searching the database using the permission vector to mask access to the one or more prohibited records during search traversal.

In Example 18, the subject matter of Example 17 includes, wherein: the records comprise vectors; and the searching of the database comprises a vector search operation.

In Example 19, the subject matter of Examples 17-18 includes, wherein: the searching of the database using the permission vector to mask access to the one or more prohibited records during search traversal comprises: accessing an adjacency matrix indicating adjacency relationships among a plurality of nodes of a graph index of the database, each node of the plurality of nodes corresponding to a record of the plurality of records; applying the permission vector to the adjacency matrix to generate a masked adjacency matrix in which adjacency relationships with nodes corresponding to the prohibited records are masked; and searching the database using the masked adjacency matrix to mask access to the one or more prohibited records during search traversal.

Example 20 is a method comprising: accessing a permission vector indicating access rights for a user to a plurality of records stored in a database, the access rights indicating one or more prohibited records of the plurality of records; and searching the database using the permission vector to mask access to the one or more prohibited records during search traversal.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. One or more processors comprising processing circuitry to perform operations comprising:
accessing a permission vector indicating access rights for a user to a plurality of records stored in a database, the access rights indicating one or more prohibited records of the plurality of records; and
searching the database using the permission vector to mask access to the one or more prohibited records during search traversal.

2. The one or more processors of claim 1, wherein:
the records comprise vectors; and
the searching of the database comprises a vector search operation.

3. The one or more processors of claim 2, wherein:
the searching of the database using the permission vector to mask access to the one or more prohibited records during search traversal comprises:
accessing an adjacency matrix indicating adjacency relationships among a plurality of nodes of a graph index of the database, each node of the plurality of nodes corresponding to a record of the plurality of records;
applying the permission vector to the adjacency matrix to generate a masked adjacency matrix in which adjacency relationships with nodes corresponding to the prohibited records are masked; and
searching the database using the masked adjacency matrix to mask access to the one or more prohibited records during search traversal.

4. The one or more processors of claim 3, wherein the operations further comprise:
accessing access control data representing access rights of a plurality of access groups to the plurality of records;
accessing user group membership data indicating membership of the user in one or more access groups of the plurality of access groups; and
generating the permission vector by applying the user group membership data to the access control data.

5. The one or more processors of claim 4, wherein the operations further comprise:
storing a plurality of permission vectors for a plurality of users;
detecting a change in access rights for at least one user of the plurality of users; and
invalidating only the stored permission vector for the at least one user whose access rights changed.

6. The one or more processors of claim 3, wherein the operations further comprise:
determining whether the masked adjacency matrix satisfies a sparsity condition; and
based on whether the masked adjacency matrix satisfies the sparsity condition, either:
performing the search traversal as a brute-force traversal of the plurality of records; or
performing the search traversal as a traversal of the graph index.

7. The one or more processors of claim 3, wherein the operations further comprise:
determining a computational efficiency metric based on a sparsity of the masked adjacency matrix; and
selecting hardware-accelerated matrix operations for the search traversal based on the computational efficiency metric.

8. The one or more processors of claim 3, wherein:
the adjacency matrix is stored in a compressed sparse format; and
the search traversal is performed using sparse matrix multiplication operations optimized for the compressed sparse format.

9. The one or more processors of claim 3, wherein the operations further comprise:
in response to a change in the access rights for the user to the plurality of records:
updating the permission vector; and
not changing the adjacency matrix.

10. The one or more processors of claim 2, wherein:
the search traversal comprises brute-force traversal of the plurality of records.

11. The one or more processors of claim 10, wherein:
the records comprise vectors; and
the brute-force traversal of the plurality of records comprises:
performing a dense matrix multiplication operation using the permission vector to compute vector distances only between records that satisfy the access rights.

12. The one or more processors of claim 3, wherein:
the search traversal comprises traversal of the graph index.

13. The one or more processors of claim 12, wherein:
the traversal of the graph index comprises:
accessing a search query;
traversing the graph index, using the masked adjacency matrix to mask access to the one or more prohibited records, to identify a plurality of candidate records; and
generating a search result comprising one or more records selected from the plurality of candidate records by applying a similarity metric.

14. The one or more processors of claim 13, wherein:
the traversing of the graph index comprises:
identifying a first number of candidate records as non-masked nodes adjacent to a starting node of the graph index using the masked adjacency matrix, the non-masked nodes corresponding to records that are not prohibited records;
determining that the first number is less than a threshold number of candidate records;
applying an inverse of the permission vector to the adjacency matrix to identify the prohibited records adjacent to the starting node; and
for each of one or more of the prohibited records adjacent to the starting node:
identifying one or more additional non-masked candidate records adjacent to the prohibited record adjacent to the starting node using the masked adjacency matrix; and
identifying the plurality of candidate records as the first number of candidate records and the one or more additional non-masked candidate records.

15. The one or more processors of claim 14, wherein:
the records comprise vectors; and
the similarity metric comprises a vector proximity measure.

16. The one or more processors of claim 15, wherein:
the adjacency relationships of the adjacency matrix are determined based on vector proximity between the records corresponding to the nodes.

17. A system comprising one or more processors to perform operations comprising:
accessing a permission vector indicating access rights for a user to a plurality of records stored in a database, the access rights indicating one or more prohibited records of the plurality of records; and
searching the database using the permission vector to mask access to the one or more prohibited records during search traversal.

18. The system of claim 17, wherein:
the records comprise vectors; and
the searching of the database comprises a vector search operation.

19. The system of claim 17, wherein:
the searching of the database using the permission vector to mask access to the one or more prohibited records during search traversal comprises:
accessing an adjacency matrix indicating adjacency relationships among a plurality of nodes of a graph index of the database, each node of the plurality of nodes corresponding to a record of the plurality of records;
applying the permission vector to the adjacency matrix to generate a masked adjacency matrix in which adjacency relationships with nodes corresponding to the prohibited records are masked; and
searching the database using the masked adjacency matrix to mask access to the one or more prohibited records during search traversal.

20. A method comprising:
accessing a permission vector indicating access rights for a user to a plurality of records stored in a database, the access rights indicating one or more prohibited records of the plurality of records; and
searching the database using the permission vector to mask access to the one or more prohibited records during search traversal.
